(19) United States
(12) Patent Application Publication
(10) Pub. No.: US 2011/0091106 A1
(43) Pub. Date: Apr. 21, 2011

(54) Image Processing Method And System

(75) Inventors: Libo Fu, Shenzhen City (CN); Jianyu Wang, Shenzhen City (CN)

(73) Assignee: TENCENT TECHNOLOGY (SHENZHEN) COMPANY LIMITED, Shenzhen City (CN)

(21) Appl. No.: 12/980,691

(22) Filed: Dec. 29, 2010

Related U.S. Application Data
(63) Continuation of application No. PCT/CN2009/074187, filed on Sep. 24, 2009.

(30) Foreign Application Priority Data
Sep. 28, 2008 (CN) 200810167131.3

(51) Int. Cl. G06K 9/00

(52) U.S. Cl. 382/170

(57) ABSTRACT

The embodiments of the present invention provide an image processing method, including: establishing an integral histogram; and calculating a histogram of an arbitrary rectangle area in an image by using the integral histogram. The embodiments of the present invention also provide an image processing system, including an integral histogram establishing unit and a histogram calculating unit. The histogram calculating unit is adapted to calculate a histogram of an arbitrary rectangle area in an image by using an integral histogram established by the integral histogram establishing unit.

### CROSS-REFERENCE TO RELATED APPLICATIONS

This application is a continuation of International Application No. PCT/CN2009/074187, filed Sep. 24, 2009. This application claims the benefit and priority of Chinese Patent Application No. 200810167131.3, filed Sep. 28, 2008. The entire disclosures of each of the above applications are incorporated herein by reference.

### FIELD

The present disclosure relates to image processing technologies, more particularly, to an image processing method and system.

### BACKGROUND

This section provides background information related to the present disclosure which is not necessarily prior art.

In image analysis and identification technologies, it is usually needed to calculate a histogram of a pixel-based observation characteristic in a certain area of an image; for example, the observation characteristic may be color or grey, or a conversion value of color or grey, such as a gradient or a conversion coefficient. The histogram indicates texture details in the area of the image, and is a basic characteristic used for image matching and identification. The image matching is a basic technology in the image analysis and identification field, and is widely applied to image search based on contents, finding of similar images, near-duplicate image detection, monitoring and intercepting of sensitive images in Internet. A conventional algorithm used for image matching has relatively large calculation amount, and thus is difficult to be used to process mass images. For example, for a Scale Invariant Feature Transform (SIFT) descriptor, it is needed to repeatedly calculate histograms of gradient in adjacent areas of different scales for hundreds or thousands of key points in one image. Since the calculation amount of calculating the histograms is too large, the speed of processing the image is too slow. For example, it needs to take several seconds averagely for a conventional commonly-configured PC to process a common image of 100 thousand pixels.

A conventional method for calculating a histogram is described hereinafter. In the conventional method for calculating the histogram, each point in a supporting area is traversed, a contribution value of a characteristic f at this point is calculated, a subscript of an interval of the histogram corresponding to the characteristic f is obtained according to a quantization rule of the histogram, and then 1 is added to the interval. This procedure may be represented as:

the subscript of the interval of the histogram=Q(f); H (subscript of interval of histogram)←H(subscript of interval of histogram)+1.

If the histogram is equably quantized, I=Q(f)=(f−fₘᵢₙ)/w; where, I represents a subscript sequence of the interval of the histogram, fₘᵢₙ is a lower limit of the quantized interval of the histogram, and w is a distance of the equable quantization. Finally, necessary processing such as normalization is performed for the histogram.

The disadvantage of the method lies in that calculation times of calculating the histogram is proportional to the number of points in the supporting area, so the calculation times and needed time for calculating the histogram is excessive. When multiple histograms are calculated, if supporting areas of the histograms overlap, repeated calculations can not be avoided. For example, when a Histogram of Gradient (HoG) is calculated, it is usually needed to perform calculations in large numbers of areas of the image, and even it is needed to perform calculations in adjacent areas of different scales for image pixels, which brings huge calculation amount. For example, traversing all points in a two-dimension image is a double cycle; when a HoG of adjacent areas of a point is calculated, it is needed to traverse all points in the adjacent areas of the point, and the traversing is also a double cycle. Therefore, if a HoG of adjacent areas of each point in the image is calculated, the performed traversing is a quadruple cycle; if a HoG of adjacent areas of different scales is calculated, the performed traversing is a five-fold cycle, which includes large numbers of repeated calculations. In practical applications, huge calculation amount limits quantization series of scales of adjacent areas, the size of adjacent areas and sampling density of interest points, and thus limits performances of the HoG. Herein, the HoG is a statistic histogram representing amplitudes or directions of gradient of grey values (color values) in a local area of an image, indicates texture details of the local area of the image, and is an important characteristic used for image matching and object identification. For example, the SIFT descriptor widely used for object identification is generated by dividing adjacent areas of an interest point in the image into grids, calculating a HoG in each grid, and performing smoothing processing and normalization for the HoG.

In addition, the establishing of a common histogram may be affected by the boundary of supporting area of the histogram and a boundary effect of interval division of the histogram. When the SIFT descriptor is extracted, the boundary effect can magnify the effect of a localization error of the interest point and the effect of image fuzziness, thereby decreasing the stability of the SIFT descriptor, and thus decreasing the accuracy of image matching.

### SUMMARY

This section provides a general summary of the disclosure, and is not a comprehensive disclosure of its full scope or all of its features.

Embodiments of the present invention provide an image processing method and system, so as to reduce calculation amount of calculating a histogram and improve the speed of image processing such as image matching and image identification.

An image processing method provided by the embodiments of the present invention includes:

establishing an integral histogram in a process of extracting a local characteristic of an image, an image matching process, or an image identification process; and

calculating a histogram of an arbitrary rectangle area in the image by using the integral histogram.

The embodiments of the present invention also provide an image processing system, including:

an integral histogram establishing unit and a histogram calculating unit, wherein

the histogram calculating unit is adapted to calculate a histogram of an arbitrary rectangle area in an image by using an integral histogram established by the integral histogram establishing unit in a process of extracting a local characteristic of an image, an image matching process or an image identification process.

In the embodiments of the present invention, an integral histogram is established, and a histogram of an arbitrary area in the image is calculated by using the integral histogram, which not only greatly reduces the calculation amount of calculating the histogram, but also increases the speed of calculating the histogram, and thus increases the speed of image processing such as image matching and image identification. In addition, by performing smoothing processing for the histogram, the potential boundary effect caused by the supporting area boundary of the histogram and interval quantization can be reduced, the stability of calculation results of the histogram can be increased, and thus the accuracy of image matching can be increased.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating an image processing method based on an integral histogram in accordance with an embodiment of the present invention.

FIG. 2 is a flowchart illustrating a process of establishing an integral histogram in accordance with an embodiment of the present invention.

FIG. 3 is a flowchart illustrating a process of establishing a histogram during initialization in accordance with an embodiment of the present invention.

FIG. 4 is a flowchart illustrating a process of establishing a histogram during initialization in accordance with another embodiment of the present invention.

FIG. 5 is a flowchart illustrating a process of performing smoothing processing for an established histogram in accordance with an embodiment of the present invention.

FIG. 6 is a schematic diagram illustrating an image processing system based on an integral histogram in accordance with an embodiment of the present invention.

FIG. 7 is a block diagram illustrating the structure of an integral histogram establishing unit in accordance with an embodiment of the present invention.

FIG. 8 is a block diagram illustrating the structure of an integral histogram establishing unit in accordance with another embodiment of the present invention.

FIG. 9 is a schematic diagram illustrating an established integral histogram in accordance with an embodiment of the present invention.

The object, functions and merits of the present invention will be illustrated in detail hereinafter with reference to the accompanying drawings and specific embodiments.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In an image processing method and system based on an integral histogram provided by the embodiments of the present invention, an integral histogram is established, and a histograms of an arbitrary area in an image are calculated by using the integral histogram, thereby greatly reducing the calculation amount of calculating the histogram, increasing the speed of calculating the histogram, and thus increasing the speed of image processing such as image matching and image identification. In addition, by performing smoothing processing for the histogram, the potential boundary effect caused by supporting area boundary of the histogram and interval quantization can be reduced, the stability of calculation results of the histogram can be increased, and thus the accuracy of image matching can be increased. The images in the embodiments of the present invention are all decoded images.

FIG. 1 is a flowchart illustrating an image processing method based on an integral histogram in accordance with an embodiment of the present invention. The image processing method includes the following steps.

Step S1, an integral histogram is established;

Step S2, a histograms of an arbitrary rectangle area in an image are calculated by using the integral histogram.

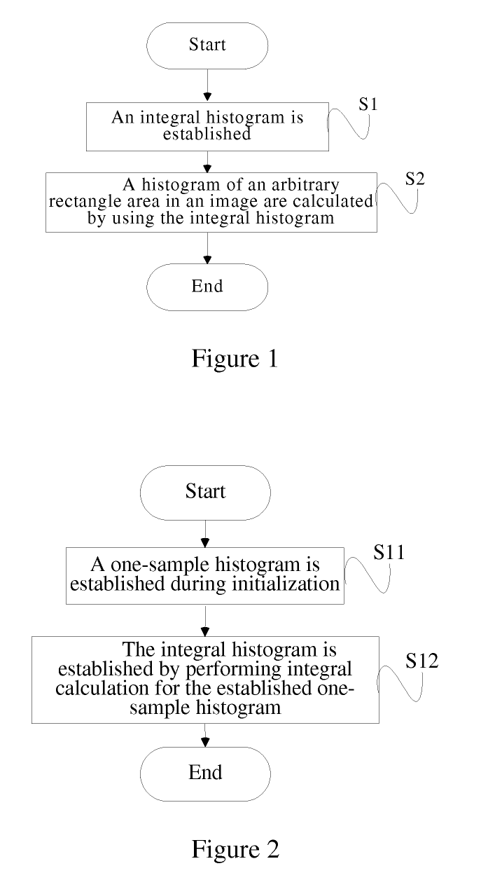

In order to better describe the embodiment shown in FIG. 1, FIG. 2 shows a flowchart illustrating a process of establishing an integral histogram in accordance with an embodiment of the present invention. The process includes the following steps.

Step S11, a one-sample histogram is established during initialization.

Step S12, the integral histogram is established by performing integral calculation for the established one-sample histogram.

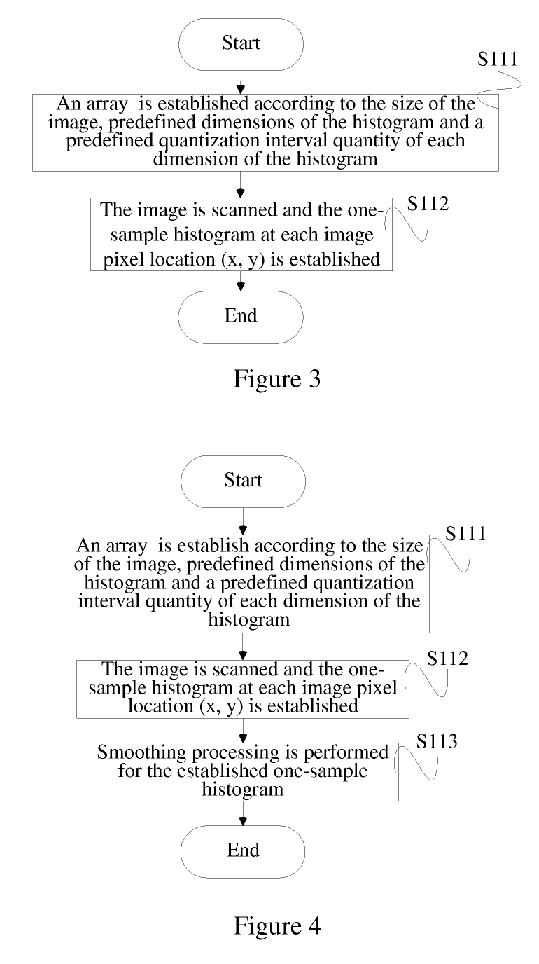

In order to better describe the embodiment shown in FIG. 2, FIG. 3 shows a flowchart illustrating a process of establishing a one-sample histogram during initialization in accordance with an embodiment of the present invention. The process includes the following steps.

Step S111, an array H of W×L×K₁×K₂× . . . ×K_{D} is established according to the size of the image, predefined dimensions of the histogram and a predefined quantization interval quantity of each dimension of the histogram. Where, elements of the array are H(x, y, I), and the H(x, y, I) represents an interval of the histogram at an image pixel location (x, y); W and L represent the width and height of the image, 1≦x≦W, 1≦y≦L; K₁, K₂, . . . , K_{D} respectively represent the predefined quantization interval quantity of each dimension of the histogram; D represents the predefined dimensions of the histogram, D≧1; I is a simplified representation of a subscript sequence (i₁, i₂, . . . , i_{D}) of intervals of the histogram, i.e., I=(i₁, i₂, . . . , i_{D}), 1≦i₁≦K₁, 1≦i₂≦K₂, . . . , 1≦i_{D}≦K_{D}; that is, IεZ[1, K₁]× . . . ×Z[1, K_{D}], Z[1, K_{d}] represents an integer set from 1 to K_{d}, d=1, 2, . . . D. Initial values of all elements in the array H are zero.

Step S112, the image is scanned and the one-sample histogram at each image pixel location (x, y) is established.

In an embodiment, establishing the one-sample histogram at each image pixel location (x, y) includes: for a characteristic f at a scanned image pixel location (x, y), a subscript I₀=(i0₁, i0₂, . . . , i0_{D}) of an interval of the histogram corresponding to the characteristic f is obtained according to a quantization rule of the histogram I=Q(f), and 1 is added to an interval H(x, y, I₀) of the histogram corresponding to I₀, i.e. H(x, y, I₀)←H (x, y, I₀)+1, so that, at each image pixel location (x, y), the one-sample histogram including only the characteristic f at the image pixel location is established; where, I₀ represents a specific value of I.

The process of establishing the integral histogram in Step S12 will be described hereinafter based on the one-sample histogram established in Step S11. In Step 12 of the embodiment shown in FIG. 2, the integral histogram is established by performing the integral calculation for the established one-sample histogram; specifically, the image is scanned from above to below and from left to right, local integral of the one-sample histogram is calculated during the scanning procedure, and the integral histogram is established after the scanning procedure is finished.

The local integral of the one-sample histogram is calculated according to the following recursion formula:

H(x,y,I)←H(x,y,I)+H(x−1,y,I)+H(x,y−1,I)−H(x−1,y−1,I) ∀IεZ[1, K₁]×Z[1, K₂]× . . . ×Z[1, K_{D}].

Where, when x or y is zero,

H(x,y,I)=0.

In an embodiment, an integral histogram shown in FIG. 9 may be established.

For the three-dimensional array H in the embodiment, each one-dimensional sub-array in the array is partial integral of the one-sample histogram, i.e., a partial sum of one-sample histograms at all image pixel locations (including the image pixel location (x, y)) which are located at the left upper corner of the image pixel location (x, y).

Step S2 will be described hereinafter based on the integral histogram established in Step S12. In Step S2 of the embodiment shown in FIG. 1, calculating the histogram of the arbitrary rectangle area in the image by using the integral histogram includes: according to coordinate values of four apexes of the arbitrary rectangle area in the image to which the integral histogram corresponds, calculating a histogram of the characteristic f at the rectangle area.

In an embodiment, if the coordinate values of the four apexes of the arbitrary rectangle area in the image are (x₀, y₀), (x₁, y₀), (x₀, y₁), (x₁, y₁), the histogram of the characteristic f at the rectangle area may be calculated according to the following formula:

H(x₀−1,y₀−1,I)−H(x₁,y₀−1,I)−H(x₀−1,y₁,I)+H(x₁,y₁,I) ∀IεZ[1, K₁]×Z[1, K₂]× . . . ×Z[1, K_{D}];

where,

1≦x₀<x₁≦W,1≦y₀<y₁≦L.

Based on the embodiment shown in FIG. 3, FIG. 4 shows a flowchart illustrating a process of establishing a histogram during initialization in accordance with another embodiment of the present invention. The process includes the following steps.

Step S111, an array H of W×L×K₁×K₂× . . . ×K_{D} is established according to the size of the image, predefined dimensions of the histogram and a predefined quantization interval quantity of each dimension of the histogram. Where, elements of the array are H(x, y, I), and the H(x, y, I) represents an interval of the histogram at an image pixel location (x, y); W and L represent the width and height of the image, 1≦x≦W, 1≦y≦L; D represents the predefined dimensions of the histogram, D≧1; K₁, K₂, . . . , K_{D} respectively represent the predefined quantization interval quantity of each dimension of the histogram; I is a simplified representation of a subscript sequence (i₁, i₂, . . . , i_{D}) of intervals of the histogram, i.e. I=(i₁, i₂, . . . , i_{D}), 1≦i₁≦K₁, 1≦i₂≦K₂, . . . , 1≦i_{D}≦K_{D}; that is, IεZ[1, K₁]×Z[1, K₂]× . . . ×Z[1, K_{D}], Z[1, K_{d}] represents an integer set from 1 to K_{D}, d=1, 2, . . . D. Initial values of all elements in the array H are zero.

Step S112, for a characteristic f at a scanned image pixel location (x, y), a subscript I₀=(i0₁, i0₂, . . . , i0_{D}) of an interval of the histogram corresponding to the characteristic f is obtained according to a quantization rule of the histogram I=Q(f), and 1 is added to an interval H(x, y, I₀) of the histogram corresponding to I₀, i.e. H(x, y, I₀)←H(x, y, I₀)+1 so that, at each image pixel location (x, y), the one-sample histogram including only the characteristic f at the image pixel is established.

Step S113, smoothing processing is performed for the one-sample histogram established after Steps S111 and S112.

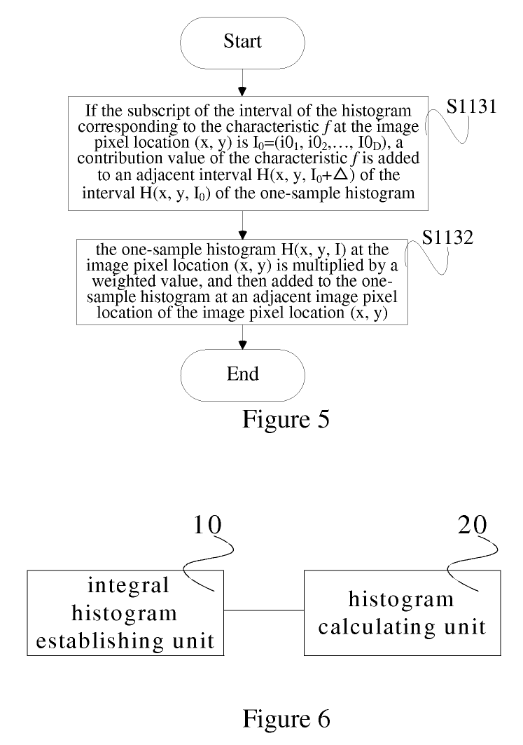

In order to eliminate the effect of the boundary effect on the histogram, FIG. 5 shows a process of performing smoothing processing for the established one-sample histogram in accordance with an embodiment of the present invention. The process includes the following steps.

Step S1131, if the subscript of the interval of the histogram corresponding to the characteristic f at the image pixel location (x, y) is I₀=(i0₁, i0₂, . . . , i0_{D}), a contribution value of the characteristic f is added to an adjacent interval H(x, y, I₀+Δ) of the interval H(x, y, I₀) of the one-sample histogram, where, Δ=(δ₁, δ₂, . . . , δ_{D}), δ_{d}= . . . , −2, −1, 0, 1, 2, . . . , and, d=1, 2, . . . , D; and I₀+ΔεZ[1, K₁]×Z[1, K₂]× . . . ×Z[1, K_{D}] should be ensured.

In an embodiment, the contribution value of the characteristic f may be

$$\{ \begin{matrix}1 - {\sum }_{d = 1}^{D} \frac{{δ}_{d}}{{K}_{d}} & 1 - {\sum }_{d = 1}^{D} \frac{{δ}_{d}}{{K}_{d}} > 0 \\ 0 & else ,\end{matrix}$$

where 1<δ_{d}<K_{d}, d=1, 2, . . . , D.

Step S1132, the one-sample histogram H(x, y, I) at the image pixel location (x, y) is multiplied by a weighted value, and then added to the one-sample histogram at an adjacent image pixel location of the image pixel location (x, y), i.e. H(x+Δx, y+Δy, I)←H(x+Δx, y+Δy, I)+a×H(x, y, I), ∀IεZ[1, K₁]×Z[1, K₂]× . . . ×Z[1, K_{D}]; where, Δx and Δy are distances between the adjacent image pixel location and the image pixel location (x, y) at the x direction and at the y direction respectively, and a is a weighted value less than 1; in an embodiment a=e^{-99Δx}^{²}^{+(Δy)}^{²}⁾.

In the embodiment, the characteristic f at the image pixel location (x, y) not only has a contribution value for this image pixel location, but also has a contribution value for the adjacent image pixel location of this image pixel location. In this way, the deviation of image area for calculating the histogram will not make the value of the histogram change remarkably. The characteristic f not only has a contribution value for the interval of the histogram corresponding to the characteristic f, but also has a contribution value for each adjacent interval of this interval of the histogram; in this way, the deviation of quantization intervals of the histogram will not make the value of the histogram change remarkably.

FIG. 6 shows a schematic diagram illustrating an image processing system based on an integral histogram in accordance with an embodiment of the present invention. The image processing system includes an integral histogram establishing unit 10 and a histogram calculating unit 20.

The integral histogram establishing unit 10 is adapted to establish an integral histogram.

The histogram calculating unit 20 is connected with the integral histogram establishing unit 10, and is adapted to calculate a histogram of an arbitrary rectangle area in an image by using the integral histogram established by the integral histogram establishing unit 10.

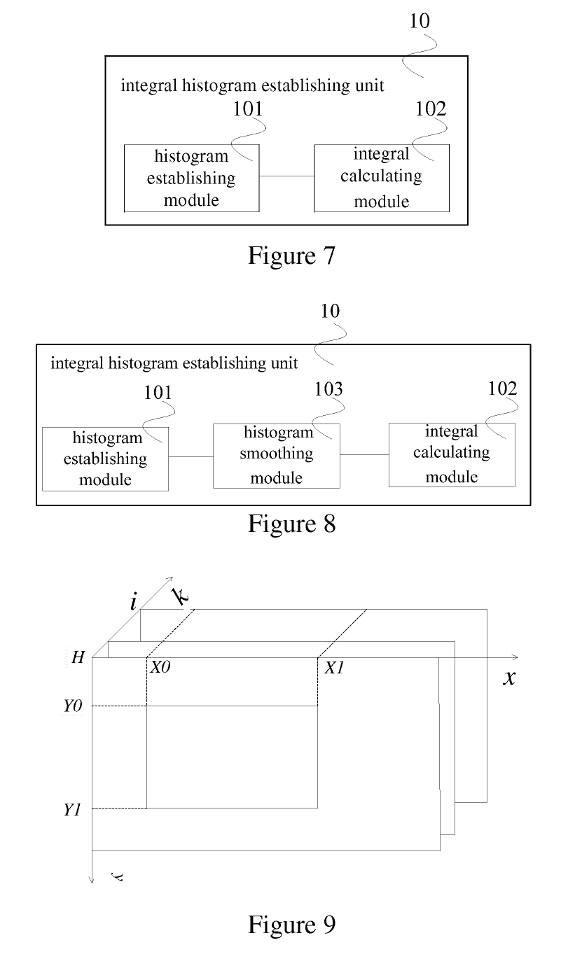

In order to further describe the embodiment shown in FIG. 6, FIG. 7 shows a schematic diagram illustrating the structure of the integral histogram establishing unit 10 in accordance with an embodiment of the present invention. The integral histogram establishing unit 10 includes a histogram establishing module 101 and an integral calculating module 102.

The histogram establishing module 101 is adapted to establish a one-sample histogram. The histogram establishing module 101 may establish the one-sample histogram according to the embodiment shown in FIG. 3.

The integral calculating module 102 is connected with the histogram establishing module 101, and is adapted to perform integral calculation for the one-sample histogram established by the histogram establishing module 101 to establish the integral histogram.

The integral calculating module 102 scans the image from above to below and then from left to right, or from left to right and then from above to below, and calculates local integral of the one-sample histogram during the scanning procedure, so as to establish the integral histogram after the scanning procedure is finished. The local integral of the one-sample histogram is calculated by the integral calculating module 102 according to the following recursion formula: H(x, y, I)←H(x, y, I)+H(x−1, y, I)+H(x, y−1, I)−H(x−1, y−1, I) ∀IεZ[1, K₁]×Z[1, K₂]× . . . ×Z[1, K_{D}]. Where, when x or y is zero, H(x, y, I)=0.

In order to further describe the embodiment shown in FIG. 6, FIG. 8 is a schematic diagram illustrating the structure of the integral histogram establishing unit 10 in accordance with another embodiment of the present invention. The integral histogram establishing unit 10 includes a histogram establishing module 101, an integral calculating module 102 and a histogram smoothing module 103.

The histogram establishing module 101 is adapted to establish a one-sample histogram;

The histogram smoothing module 103 is connected with the histogram establishing module 101, and is adapted to perform smoothing processing for the established one-sample histogram. The histogram smoothing module 103 may perform the smoothing processing for the one-sample histogram according to the embodiment shown in FIG. 5.

The integral calculating module 102 is connected with the histogram smoothing module 103, and is adapted to perform integral calculation for the one-sample histogram after the smoothing processing to establish the integral histogram.

In the image processing method and system based on the integral histogram provided by the embodiments of the present invention, after the integral histogram is established, the histogram at a rectangle supporting area of any location and any size can be calculated in constant time; especially, in a situation that sampling density is high and a HoG of multiple scales needs to be calculated, calculation amount can be greatly reduced. The embodiments of the present invention are not only applicable to a case of extracting a local characteristic of an image, e.g. HoG characteristic, but also applicable to applications such as image matching and image identification.

The foregoing is only preferred embodiments of the present invention and is not for use in limiting the invention. Any modification, equivalent substitution, and improvement within the spirit and principle of the invention should be covered in the protection scope of the invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An image processing method, comprising:
establishing an integral histogram in a process of extracting a local characteristic of an image, an image matching process, or an image identification process; and
calculating a histogram of an arbitrary rectangle area in the image by using the integral histogram.

2. The method of claim 1, wherein establishing an integral histogram comprises:
establishing a one-sample histogram during initialization; and
establishing the integral histogram by performing integral calculation for the established one-sample histogram.

3. The method of claim 2, wherein establishing a one-sample histogram during initialization comprises:
establishing an array H of W×L×K₁×K₂× . . . ×K_{D} according to the size of the image, predefined dimensions of the histogram and a predefined quantization interval quantity of each dimension of the histogram; where, elements of the array H are H(x, y, I), and the H(x, y, I) represents an interval of the histogram at an image pixel location (x, y); W and L represent the width and height of the image, 1≦x≦W, 1≦y≦L; D represents the predefined dimensions of the histogram, D≧1; K₁, K₂, . . . , K_{D} respectively represent the predefined quantization interval quantity of each dimension of the histogram; I=(i₁, i₂, . . . , i_{D}), (i₁, i₂, . . . , i_{D}) is a subscript sequence of intervals of the histogram, and 1≦i₁≦K₁, 1≦i₂≦K₂, . . . , 1≦i_{D}≦K_{D}; IεZ[1, K₁]×Z[1, K₂]× . . . ×Z[1, K_{D}] Z[1, K_{d}] represents an integer set from 1 to K_{d}, d=1, 2, . . . D ; and
scanning the image, and establishing the one-sample histogram at each image pixel location (x, y).

4. The method of claim 3, wherein establishing the one-sample histogram at each image pixel location (x, y) comprises:
for a characteristic f at a scanned image pixel location (x, y), obtaining a subscript I₀=(i0₁, i0₂, . . . , i0_{D}) of an interval of a histogram corresponding to the characteristic f according to a quantization rule of the histogram I=Q(f), and adding 1 to an interval H(x, y, I₀) of the histogram corresponding to I₀.

5. The method of claim 4, wherein establishing an integral histogram further comprises:
performing smoothing processing for the established one-sample histogram.

6. The method of claim 5, wherein performing smoothing processing for the established one-sample histogram comprises:
if the subscript of the interval of the histogram corresponding to the characteristic f at the image pixel location (x, y) is I₀=(i0₁, i0₂, . . . , i0_{D}), adding a contribution value of the characteristic f to an adjacent interval H(x, y, I₀+Δ) of the interval of the one-sample histogram H(x, y, I₀), where, Δ=(δ₁, δ₂, . . . , δ_{D}), δ_{d}= . . . , −2, −1, 0, 1, 2, . . . d=1, 2, . . . , D;
multiplying the one-sample histogram H(x, y, I) at the image pixel location (x, y) by a weighted value, and adding the one-sample histogram H(x, y, I) to a one-sample histogram at an adjacent image pixel location of the image pixel location (x, y), where, the weighted value is less than 1.

7. The method of claim 4, wherein performing integral calculation for the established one-sample histogram to establish the integral histogram comprises:
scanning the image, calculating local integral of the one-sample histogram during the scanning procedure, and establishing the integral histogram after the scanning procedure is finished.

8. The method of claim 7, wherein the local integral of the one-sample histogram is calculated according to a following recursion formula:
H(x,y,I)←H(x,y,I)+H(x−1,y,I)+H(x,y−1,I)−H(x−1,y−1,I) ∀IεZ[1, K₁]×Z[1, K₂]× . . . ×Z[1, K_{D}].

9. The method of claim 8, wherein calculating a histogram of an arbitrary rectangle area in the image by using the integral histogram comprises:
based on coordinate values of four apexes of the arbitrary rectangle area in the image to which the integral histogram corresponds, calculating the histogram of the characteristic f at the arbitrary rectangle area.

10. The method of claim 9, wherein
the coordinate values of four apexes of the arbitrary rectangle area in the image are (x₀, y₀), (x₁, y₀), (x₀, y₁), (x₁, y₁) image are; and
the histogram of the characteristic f at the arbitrary rectangle area is calculated according to a following formula:
H(x₀−1,y₀31 1,I)−H(x₁,y₀−1,I)−H(x₀−1,y₁,I)+H(x₁,y₁,I) ∀IεZ[1, K₁]×Z[1, K₂]× . . . ×Z[1, K_{D}],
where,
1≦x₀<x₁≦W,1≦y₀<y₁≦L.

11. The method of claim 6, wherein performing integral calculation for the established one-sample histogram to establish the integral histogram comprises:
scanning the image, calculating local integral of the one-sample histogram during the scanning procedure, and establishing the integral histogram after the scanning procedure is finished.

12. The method of claim 11, wherein the local integral of the one-sample histogram is calculated according to a following recursion formula:
H(x,y,I)←H(x,y,I)+H(x−1,y,I)+H(x,y−1,I)−H(x−1,y−1,I), ∀IεZ[1, K₁]×Z[1, K₂]× . . . ×Z[1, K_{D}].

13. The method of claim 12, wherein calculating a histogram of an arbitrary rectangle area in the image by using the integral histogram comprises:
based on coordinate values of four apexes of the arbitrary rectangle area in the image to which the integral histogram corresponds, calculating the histogram of the characteristic f at the arbitrary rectangle area.

14. The method of claim 13, wherein
the coordinate values of four apexes of the arbitrary rectangle area in the image are (x₀, y₀), (x₁, y₀), (x₀, y₁), (x₁, y₁); and
the histogram of the characteristic f at the arbitrary rectangle area is calculated according to a following formula:
H(x₀−1,y₀−1,I)−H(x₁,y₀−1,I)−H(x₀−1,y₁,I)+H(x₁,y₁,I) ∀IεZ[1, K₁]×Z[1, K₂]× . . . ×Z[1, K_{D}],
where,
1≦x₀<x₁≦W,1≦y₀<y₁≦y₁≦L.

15. An image processing system, comprising:
an integral histogram establishing unit and a histogram calculating unit, wherein
the integral histogram establishing unit is adapted to establish an integral histogram in a process of extracting a local characteristic of an image, an image matching process or an image identification process; and
the histogram calculating unit is adapted to calculate a histogram of an arbitrary rectangle area in the image by using the integral histogram established by the integral histogram establishing unit.

16. The system of claim 15, wherein the integral histogram establishing unit comprises
a histogram establishing module and an integral calculating module;
the histogram establishing module is adapted to establish a one-sample histogram; and
the integral calculating module is adapted to perform integral calculation for the established one-sample histogram to establish the integral histogram.

17. The system of claim 16, further comprising:
a histogram smoothing module, adapted to perform smoothing processing for the one-sample histogram established by the histogram establishing module.
